(19) United States
(12) Patent Application Publication
(10) Pub. No.: US 2025/0392950 A1
(43) Pub. Date: Dec. 25, 2025

(54) REPORT TRIGGERING

(71) Applicant: Nokia Technologies Oy, Espoo (FI)

(72) Inventors: Benoist Pierre SEBIRE, Tokyo (JP); Chunli WU, Beijing (CN)

(73) Assignee: Nokia Technologies Oy, Espoo (FI)

(21) Appl. No.: 18/880,378

(22) PCT Filed: Jul. 5, 2022
(86) PCT No.: PCT/CN2022/103932

§ 371 Date: Dec. 31, 2024

(51) Int. Cl. H04W 28/02; H04W 72/21

(52) U.S. Cl. CPC H04W 28/0278; H04W 72/21

(57) ABSTRACT

Embodiments of the present disclosure relate to report triggering. The terminal device determines that a report is to be triggered when uplink data arrives in an empty buffer in the terminal device for at least one logic channel. The terminal device triggers the report after receiving an uplink grant from a network device. In this way. an efficient mechanism to trigger a report for every data burst may be defined. Such report triggering mechanism facilitates the network device to take the right scheduling decisions even for services with high variability of the bit rate.

### FIELD

Embodiments of the present disclosure generally relate to the field of communication, and in particular, to report triggering.

### BACKGROUND

Scheduled transmission based on shared channels (SCHs) is an essential feature of NR systems. The function of allocating shared channel resources among different UEs or different logical channels (LCHs) of the same UE is called scheduling. Scheduling belongs to the core functions of Medium Access Control (MAC) layer to satisfy the quality of service (QOS) of corresponding UEs on the one hand and to improve the efficiency of radio resource usage on the other hand. In uplink (UL) scheduling, the scheduler provides each scheduled UE a scheduling grant to indicate the set of resources in time, frequency and space of the used UL-SCH and corresponding transport format.

The UE may transmit UL data only if it receives a valid UL grant. In order to take the right scheduling decisions, the scheduler needs to consider detailed and accurate terminal status information, such as terminal buffer status and available power. Some more details should also be considered regarding the triggering of reports to provide terminal status information to the network device.

### SUMMARY

In general, example embodiments of the present disclosure provide a method, apparatus and computer readable storage medium for report triggering.

In a first aspect, there is provided a terminal device. The terminal device comprises at least one processor and at least one memory comprising computer program code. The at least one memory and the computer program code are configured to, with the at least one processor, cause the terminal device to: determine that a report is to be triggered when uplink data arrives in an empty buffer in the terminal device for at least one logic channel; and trigger the report after receiving an uplink grant from a network device.

In a second aspect, there is provided a terminal device. The terminal device comprises at least one processor and at least one memory comprising computer program code. The at least one memory and the computer program code are configured to, with the at least one processor, cause the terminal device to: determine that a report is to be triggered after the terminal device switches from a first mode in which the terminal device does not monitor a Physical Downlink Control Channel (PDCCH) to a second mode in which the terminal device monitors the PDCCH; and trigger the report after receiving an uplink grant from a network device.

In a third aspect, there is provided a network device. The network device comprises at least one processor and at least one memory comprising computer program code. The at least one memory and the computer program code are configured to, with the at least one processor, cause the network device to: determine that a report configuration is applied to at least one logic channel for a terminal device, the report configuration configuring the terminal device to determine that a report is to be triggered when uplink data arrives in an empty buffer in the terminal device for the at least one logic channel and trigger the report after receiving an uplink grant from the network device; and transmit, to the terminal device, configuration information indicating that the report configuration is applied to the at least one logic channel.

In a fourth aspect, there is provided a network device. The network device comprises at least one processor and at least one memory comprising computer program code. The at least one memory and the computer program code are configured to, with the at least one processor, cause the network device to: determine that a report configuration is applied to mode switching of a terminal device from a first mode in which the terminal device does not monitor a Physical Downlink Control Channel (PDCCH) to a second mode in which the terminal device monitors the PDCCH, the report configuration configuring the terminal device to determine that a report is to be triggered after the terminal device switches from the first mode to the second mode and trigger the report after receiving an uplink grant from the network device; and transmit, to the terminal device, configuration information indicating that the report configuration is applied to the mode switching of the terminal device.

In a fifth aspect, there is provided a method implemented at a terminal device. The method comprises: determining that a report is to be triggered when uplink data arrives in an empty buffer in the terminal device for at least one logic channel; and triggering the report after receiving an uplink grant from a network device.

In a sixth aspect, there is provided a method implemented at a terminal device. The method comprises: determining that a report is to be triggered after the terminal device switches from a first mode in which the terminal device does not monitor a Physical Downlink Control Channel (PDCCH) to a second mode in which the terminal device monitors the PDCCH; and triggering the report after receiving an uplink grant from a network device.

In a seventh aspect, there is provided a method implemented at a network device. The method comprises: determining that a report configuration is applied to at least one logic channel for a terminal device, the report configuration configuring the terminal device to determine that a report is to be triggered when uplink data arrives in an empty buffer in the terminal device for the at least one logic channel and trigger the report after receiving an uplink grant from the network device; and transmitting, to the terminal device, configuration information indicating that the report configuration is applied to the at least one logic channel.

In an eighth aspect, there is provided a method implemented at a network device. The method comprises: determining that a report configuration is applied to mode switching of a terminal device from a first mode in which the terminal device does not monitor a Physical Downlink Control Channel (PDCCH) to a second mode in which the terminal device monitors the PDCCH, the report configuration configuring the terminal device to determine that a report is to be triggered after the terminal device switches from the first mode to the second mode and trigger the report after receiving an uplink grant from the network device; and transmitting, to the terminal device, configuration information indicating that the report configuration is applied to the mode switching of the terminal device.

In a ninth aspect, there is provided an apparatus. The apparatus comprises: means for determining, at a terminal device, that a report is to be triggered when uplink data arrives in an empty buffer in the terminal device for at least one logic channel; and means for triggering the report after receiving an uplink grant from a network device.

In a tenth aspect, there is provided an apparatus. The apparatus comprises: means for determining, at a terminal device, that a report is to be triggered after the terminal device switches from a first mode in which the terminal device does not monitor a Physical Downlink Control Channel (PDCCH) to a second mode in which the terminal device monitors the PDCCH; and means for triggering the report after receiving an uplink grant from a network device.

In a eleventh aspect, there is provided an apparatus. The apparatus comprises: means for determining, at a network device, that a report configuration is applied to at least one logic channel for a terminal device, the report configuration configuring the terminal device to determine that a report is to be triggered when uplink data arrives in an empty buffer in the terminal device for the at least one logic channel and trigger the report after receiving an uplink grant from the network device; and means for transmitting, to the terminal device, configuration information indicating that the report configuration is applied to the at least one logic channel.

In a twelfth aspect, there is provided an apparatus. The apparatus comprises: means for determining that a report configuration is applied to mode switching of a terminal device from a first mode in which the terminal device does not monitor a Physical Downlink Control Channel (PDCCH) to a second mode in which the terminal device monitors the PDCCH, the report configuration configuring the terminal device to determine that a report is to be triggered after the terminal device switches from the first mode to the second mode and trigger the report after receiving an uplink grant from the network device; and means for transmitting, to the terminal device, configuration information indicating that the report configuration is applied to the mode switching of the terminal device.

In a thirteenth aspect, there is provided a computer readable medium having instructions stored thereon. The instructions, when executed on at least one processor. cause the at least one processor to perform the method according to any of the fifth to eighth aspects of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example network environment in which example embodiments of the present disclosure may be implemented;

FIG. 2 illustrates a schematic diagram illustrating a process for communication according to embodiments of the present disclosure;

FIG. 3 illustrates a schematic diagram illustrating another process for communication according to embodiments of the present disclosure;

FIG. 4 illustrates an example method of communication implemented at a terminal device in accordance with some embodiments of the present disclosure;

FIG. 5 illustrates another example method of communication implemented at a terminal device in accordance with some embodiments of the present disclosure;

FIG. 6 illustrates an example method of communication implemented at a network device in accordance with some embodiments of the present disclosure;

FIG. 7 illustrates another example method of communication implemented at a network device in accordance with some embodiments of the present disclosure;

FIG. 8 illustrates a simplified block diagram of an apparatus that is suitable for

implementing embodiments of the present disclosure; and

FIG. 9 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments that or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim clement, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

As used herein, the term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, a report containing MAC CE reporting information could be triggered to provide terminal status information to the network device so as to help the network device make scheduling decisions. For example, a Buffer Status Report (BSR) may be triggered to inform the network device of the amount of data in the buffer of the terminal device to be transmitted. A Power Headroom Report (PHR) may be triggered to inform the network device of power headroom for each activated serving cells, which could be the difference between the maximum allowable transmission power of the terminal device and the uplink transmission power currently evaluated. Thus, the network device can control power and schedule resource for the terminal device based on the terminal status information in the BSR and/or PHR.

The report trigger conditions for MAC CE reporting information are critical to enable the network device to take the right scheduling decisions. For example, in some scenarios, especially for services with high variability of the bit rate, providing a report for every data burst would be beneficial to help the network device take the right scheduling decisions. For example, a regular BSR may be triggered if UL data, for a logical channel which belongs to a logical channel group (LCG), becomes available to the MAC entity; and either this UL data belongs to a logical channel with higher priority than the priority of any logical channel containing available UL data which belong to any LCG, or none of the logical channels which belong to an LCG contains any available UL data. For periodic BSR, unless all UL grants are precisely allocated and aligned with the frame rate, providing a BSR for every data burst would not be possible as every delay in granting resources would translate in a BSR delay that cannot be compensated. Thus, there is currently no efficient mechanism to provide a BSR for every data burst defined. In addition, configured grant is also not an attractive solution for services with high variability of the bit rate such as XR service.

In addition, in some scenarios, for example where the terminal device may not need to continuously monitor the control channel so as to save power, it would be beneficial to report terminal status information to the network device each time the terminal device “wakes up”.

A new solution for providing reports containing terminal status information for services with high variability of the bit rate is needed. In addition, in scenarios where there is a need for energy saving, the mechanism for providing reports to the network device to help the network device take right scheduling decisions may need to be enhanced.

In view of this, embodiments of the present disclosure provide a solution for solving the above and other potential issues. Principle and example embodiments of the present disclosure will be described in detail below with reference to the accompanying drawings. However, it shall be noticed that the key idea of the present disclosure can be applied in any communication system or scenario which involves similar issues.

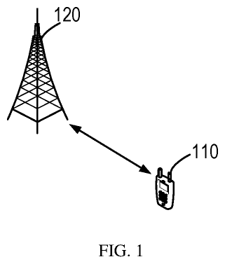

FIG. 1 illustrates an example network environment 100 in which example embodiments of the present disclosure may be implemented. The environment 100, which may be a part of a communication network, comprises a terminal device 110 and a network device 120. It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

Communications in the network environment 100 may be implemented according to any proper communication protocol(s), comprising, but not limited to, the third generation (3G), the fourth generation (4G) and the fifth generation (5G), 5.5G, 5G-Advanced networks, or the sixth generation (6G) communication protocols, and/or any other protocols either currently known or to be developed in the future, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

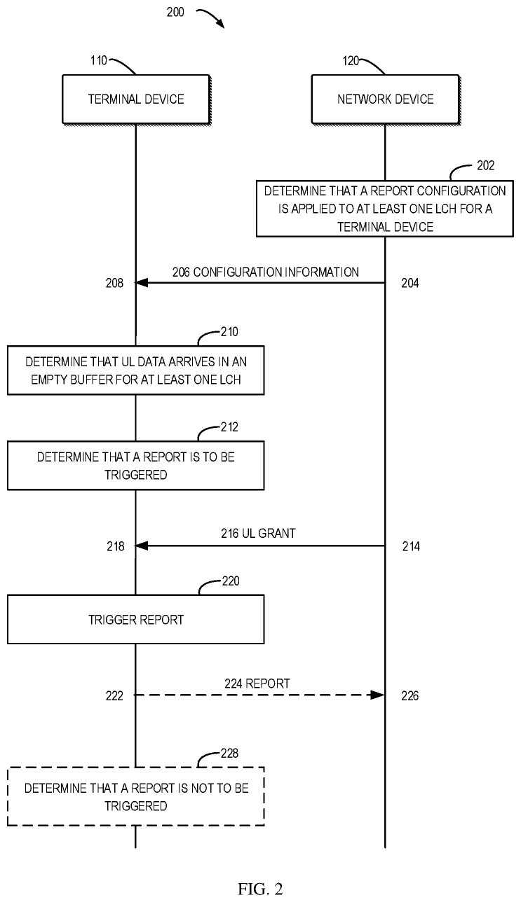

FIG. 2 illustrates a schematic diagram illustrating a process 200 for communication according to embodiments of the present disclosure. For the purpose of discussion, the process 200 will be described with reference to FIG. 1. The process 200 may involve the terminal device 110 and the network device 120 as illustrated in FIG. 1. It is to be understood that process 200 may further include additional blocks not shown and/or omit some shown blocks, and the scope of the present disclosure is not limited in this regard.

As shown in FIG. 2, the network device 120 determines (202) that a report configuration is applied to at least one logic channel for the terminal device 110. Based on the report configuration, the terminal device 110 may be configured to determine that a report is to be triggered when or after uplink data arrives in an empty buffer in the terminal device 110 for the at least one logic channel and trigger the report after receiving an uplink grant from the network device 120. Based on the determination, the network device 120 transmits (204), to the terminal device 110, configuration information 206 indicating that the report configuration is applied to the at least one logic channel. The terminal device 110 may receive (208) the configuration information 206 from the network device 120. After determining (210) that uplink data arrives in an empty buffer in the terminal device 110 for the at least one logic channel, the terminal device 110 determines (212) that a report is to be triggered. In some embodiments, the terminal device 110 may determine whether the report is to be triggered based on the report configuration for the at least one logic channel. The network device 120 may transmit (214) an uplink grant 216 to the terminal device 110. After receiving (218) the uplink grant 216 from the network device 120, the terminal device 110 triggers (220) the report. In this way, an efficient mechanism to trigger a report for every data burst may be defined. Such report triggering mechanism facilitates the network device to take the right scheduling decisions even for services with high variability of the bit rate.

In some embodiments, the terminal device 110 may transmit (222) the report 224 to the network device 120 on uplink resources scheduled by the received uplink grant 216. The network device 120 may receive (226) the report 224 and make scheduling decisions for the terminal device based on the report 224. In this way, it may facilitate the network device to take the right scheduling decisions.

In some embodiments, after transmitting (222) the report 224 to the network device 120, the terminal device 110 may determine (228) that the report is not to be triggered. In this way, it may independently from the provision of a configured uplink grant. A report can be provided at every data burst regardless of the periodicity of the burst and regardless of any periodic report timer configuration.

In some embodiments, the report may comprise at least one of a PHR, a BSR and any other MAC CE report. In this way, the terminal status information required by the network device may be provided at every data burst. In addition, in embodiments where the report comprises a BSR, no scheduling request needs to be triggered when no resource is available.

In some embodiments, the network device 120 may determine that the report configuration is applied to a set of logic channels. The set of logic channels may comprise one or more logic channels and the at least one logic channel belongs to the set of logic channels. The configuration information 206 may comprise logic channel indicators of the set of logic channels.

In some alternative embodiments, the network device 120 may determine that the report configuration is applied to one or more logic channels associated with a QoS flow indicator (QFI), a range of QFIs or a set of QFIs. One or more QFIs may be mapped to the one DRB/LCH. In some embodiments, the network device 120 may determine that the report configuration is applied to one or more logic channels associated with a set of QFIs. The at least one logic channel belongs to the one or more logic channels associated with the set of QFIs. The configuration information 206 may comprise a set of QFIs indicating that the report configuration is applied to the one or more logic channels associated with the set of QFIs. In this way, when configured QFI(s) are remapped from one LCH to another via reflective mapping, report triggering for every data burst in buffers for the at least one logic channel remapped to the configured QFI(s) may be guaranteed. In other words, the report triggering condition follows the configured QFI(s) and no RRC reconfiguration is needed.

In some embodiments, the terminal device 110 may receive the configuration information 206 via a Radio Resource Control (RRC) message. In this way, report triggering for every data burst in the buffer for each logic channels in the set of logic channels may be guaranteed.

In some embodiments, when or after the uplink data arrives in the empty buffer in the terminal device 110 for the at least one logic channel, the terminal device 110 may set a report indicator associated with the at least one logic channel to be a first value. The report indicator with the first value indicates that the report is to be triggered. In some embodiments, the report indicator may be associated with a logic channel. In other words, a report indicator may be introduced for each logic channel in the set of logic channels to which the report triggering mechanism is applied. For example, when or after arrival of uplink data in an empty buffer in the terminal device for the at least one logic channel, the terminal device 110 may set a report indicator associated with the at least one logic channel to be a first value.

In some alternative embodiments, when or after the uplink data arrives in the empty buffer in the terminal device 110 for the at least one logic channel, the terminal device 110 may set a report indicator associated with a logic channel group (LCG) comprising the at least one logic channel to be a first value. The report indicator with the first value indicates that the report is to be triggered. In some embodiments, the report indicator may be associated with a LCG. In other words, logic channels in the set of logic channels to which the report triggering mechanism is applied may belong to different LCGs. A report indicator may be introduced for each LCG. When or after arrival of uplink data in an empty buffer in the terminal device for the at least one logic channel, the terminal device 110 may set a report indicator associated with a LCG including the at least one logic channel to be a first value. As used herein, logical channel groups may be used to classify different data radio bearers (DRBs) into QoS groups. In LTE, there may be maximum four logical channel groups. In NR, there may be maximum eight logical channel groups.

In some embodiments, the terminal device 110 may set the report indicator to be a second value indicating that the report is not to be triggered. The second value is different from the first value. For example, the first value may be 0 and the second value may be 1. Or on the contrary, the first value may be 1 and the second value may be 0. As used herein, the term “report indicator” may be any explicit or implicit indicators, e.g., an explicit flag or an implicit indication.

In some embodiments, the terminal device 110 may set the report indicator to be the second value after transmitting the triggered report to the network device. For example, after transmitting the report to the network device on uplink resources scheduled by the received uplink grant, the terminal device 110 may set the report indicator associated with the at least one logic channel to be a second value. Alternatively, after transmitting the report to the network device on uplink resources scheduled by the received uplink grant, the terminal device 110 may set the report indicator associated with the LCG comprising the at least one logic channel to be a second value. In some embodiments, the terminal device 110 may set an initial value of the report indicator to be the second value. In some embodiments, the terminal device 110 may prevent to trigger the report after receiving the uplink grant from the network device 120 when the report indicator set to be the second value. In this way, the report triggering mechanism may be easily achieved.

For example, when a buffer for a LCH has fresh data awaiting transmission, the terminal device may trigger a BSR when receiving an UL grant. As used herein, the term “fresh data” refers to new data that has arrived in previously empty buffers. When new data arrives in buffers already containing data awaiting transmission, the new data is not considered as fresh data. A flag “BurstBSR” for a logic channel may be initially set to 0. When or after data arrival in an empty buffer for the at least one logic channel, the flag “BurstBSR” for the at least one logic channel may be set to 1. When an UL grant is received, the terminal device may trigger a regular BSR based on BurstBSR=1, and may set the BurstBSR to 0 after transmitting the BSR to the network device. It should be understood that the report indicator is not limited to the flag, but may be any explicit or implicit indicator. In this way, a BSR can be provided for every data burst regardless of the periodicity of the burst and regardless of the periodic BSR timer configuration. The proposed report triggering mechanism is thus independent from whether any other logic channel(s) has data buffered or from the priority of the other logic channel(s) with data buffered.

In some other example embodiments, the terminal device 110 may directly trigger a BSR when a buffer for a LCH has fresh data awaiting transmission. An SR mask can be configured for the LCH which is independent on availability of configured grant, so that it will not trigger SR when there is a BSR triggered if such mask is enabled. The triggered BSR will be included when the terminal device 110 receives an UL grant.

In some embodiments, the terminal device 110 may not need to continuously monitor the control channel so as to save power. In other words, the terminal device may periodically wake up to monitor a PDCCH during an active time and stop monitoring the PDCCH during an inactive time. For example, the terminal device may operate in a DRX configuration or in a PDCCH skipping mode. In some embodiments, the network device 120 may determine that the report configuration is further applied to mode switching of the terminal device from a first mode in which the terminal device does not monitor the PDCCH to a second mode in which the terminal device monitors the PDCCH. The network device 120 may transmit, to the terminal device, configuration information indicating that the report configuration is applied to the mode switching of the terminal device. If the report configuration is applied to the mode switching of the terminal device, after switching from the first mode to the second mode, the terminal device 110 may determine that the report is to be triggered. In this way, it may be guaranteed that the report may be triggered at the earliest for each wakeup of the terminal device when UL grant is available.

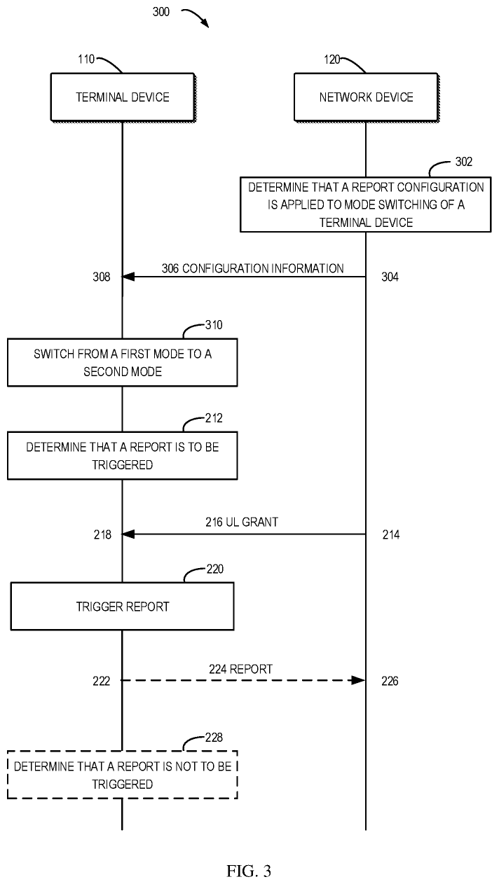

FIG. 3 illustrates a schematic diagram illustrating another process 300 for communication according to embodiments of the present disclosure. For the purpose of discussion, the process 300 will be described with reference to FIG. 1. The process 300 may involve the terminal device 110 and the network device 120 as illustrated in FIG. 1. The same reference numerals are used to denote the steps or components described in FIG. 3 having the same operations as the steps or components described in FIG. 2, and detailed description thereof will be omitted. It is to be understood that process 300 may further include additional blocks not shown and/or omit some shown blocks, and the scope of the present disclosure is not limited in this regard.

As shown in FIG. 3, the network device 120 determines (302) that a report configuration is applied to mode switching of the terminal device 110 from a first mode in which the terminal device does not monitor a PDCCH to a second mode in which the terminal device monitors the PDCCH. Based on the determination, the network device 120 transmits (304), to the terminal device 110, configuration information 306 indicating that the report configuration is applied to the mode switching of the terminal device 110. The terminal device 110 receives (308) the configuration information 306 from the network device 130. After switching (310) from the first mode to the second mode, the terminal device 110 determines (212) that a report is to be triggered. In this way, it may be guaranteed that the report may be triggered at the earliest for each wakeup of the terminal device when UL grant is available.

In some embodiments, the terminal device 110 may not need to continuously monitor the control channel so as to save power. In other words, the terminal device may periodically wake up to monitor a PDCCH during an active time and stop monitoring the PDCCH during an inactive time. For example, the terminal device may operate in a DRX configuration or in a PDCCH skipping mode.

In some example embodiments, the terminal device 110 may determine that the report is to be triggered if a buffer in the terminal device for at least one logic channel is not empty when the terminal device 110 switches from the first mode to the second mode. In this way, the report may be triggered if the terminal device has status information to report when the terminal device wakes up. In this way, resource overhead may be reduced.

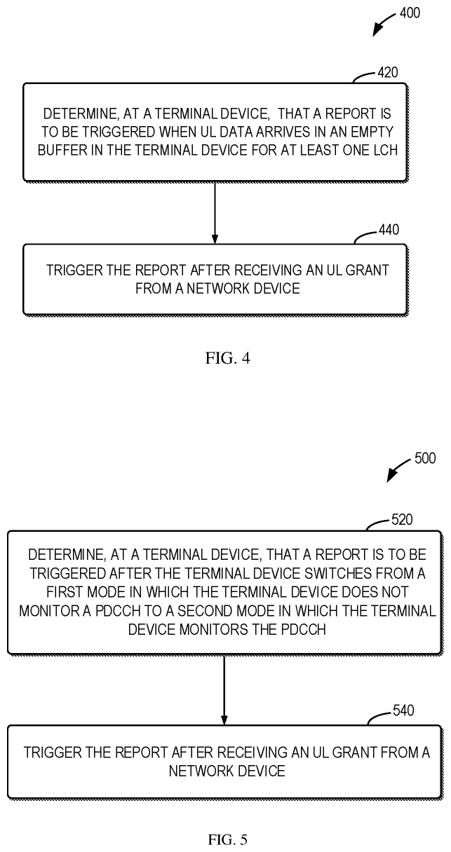

It is to be understood that the above embodiments described in connection with FIGS. 2 and 3 may be carried out separately or in any suitable combination. Accordingly, embodiments of the present disclosure provide methods of communication implemented at a terminal device and a network device. These methods will be described below with reference to FIGS. 4 to 7.

FIG. 4 illustrates an example method 400 of communication implemented at a terminal device in accordance with some embodiments of the present disclosure. For example, the method 400 may be performed at the terminal device 110 as shown in FIG. 1. For the purpose of discussion, in the following, the method 400 will be described with reference to FIG. 1. It is to be understood that the method 400 may include additional blocks not shown and/or may omit some blocks as shown, and the scope of the present disclosure is not limited in this regard. With the method 400 of FIG. 4, an efficient mechanism to trigger a report for every data burst may be defined.

At block 420, the terminal device 110 determines that a report is to be triggered when or after uplink data arrives in an empty buffer in the terminal device for at least one logic channel. At block 440, the terminal device 110 triggers the report after receiving an uplink grant from a network device. In some example embodiments, the terminal device 110 may transmit the report to the network device on uplink resources scheduled by the received uplink grant.

In some example embodiments, the terminal device 110 may set a report indicator associated with the at least one logic channel to be a first value when or after the uplink data arrives in the empty buffer for the at least one logic channel, the set report indicator with the first value indicating that the report is to be triggered. In some example embodiments, the terminal device 110 may set a report indicator associated with a logic channel group comprising the at least one logic channel to be a first value when the uplink data arrives in the empty buffer for the at least one logic channel, the set report indicator with the first value indicating that the report is to be triggered.

In some example embodiments, the terminal device 110 may set the report indicator to be a second value different from the first value indicating that the report is not to be triggered. In some example embodiments, the terminal device 110 may set the report indicator to be the second value after transmitting the triggered report to the network device. In some example embodiments, the terminal device 110 may set an initial value of the report indicator to be the second value. In some embodiments, the terminal device 110 may prevent to trigger the report after receiving the uplink grant from the network device 120 when the report indicator set to be the second value. In some example embodiments. the first value may be 0 and the second value may be 1. In some alternative embodiments, the first value may be 1 and the second value may be 0.

In some example embodiments, the determining may be based on a report configuration for the at least one logic channel. In some example embodiments, the terminal device 110 may receive, from the network device, configuration information indicating that the report configuration is applied to a set of logic channels, the at least one logic channel belonging to the set of logic channels. In some example embodiments, the configuration information may comprise logic channel indicators of the set of logic channels. In some example embodiments, the configuration information may comprise at least one Quality of Service (QOS) flow indicators indicating that the report configuration is applied to the set of logic channels associated with the at least one QoS flow indicators.

In some example embodiments, the configuration information may be received via a Radio Resource Control (RRC) message. In some example embodiments, the report may comprise at least one of a PHR and a BSR. In some example embodiments, the terminal device may determine that the report is to be triggered after the terminal device switches from a first mode in which the terminal device does not monitor a Physical Downlink Control Channel (PDCCH) to a second mode in which the terminal device monitors the PDCCH.

In some example embodiments, an apparatus capable of performing the method 400 (for example, the terminal device 110) may comprise means for performing the respective steps of the method 400. The means may be implemented in any suitable form. For example, the means may be implemented in a circuitry or software module.

In some example embodiments, the apparatus comprises: means for determining, at a terminal device, that a report is to be triggered when uplink data arrives in an empty buffer in the terminal device for at least one logic channel; and means for triggering the report after receiving an uplink grant from a network device.

FIG. 5 illustrates an example method 500 of communication implemented at a terminal device in accordance with some embodiments of the present disclosure. For example, the method 500 may be performed at the terminal device 110 as shown in FIG. 1. For the purpose of discussion, in the following, the method 500 will be described with reference to FIG. 1. It is to be understood that the method 500 may include additional blocks not shown and/or may omit some blocks as shown, and the scope of the present disclosure is not limited in this regard. With the method of FIG. 5, it may be guaranteed that the report may be triggered at the earliest for each wakeup of the terminal device when UL grant is available.

At block 520, the terminal device 110 determines that a report is to be triggered after the terminal device switches from a first mode in which the terminal device does not monitor a Physical Downlink Control Channel (PDCCH) to a second mode in which the terminal device monitors the PDCCH. At block 540, the terminal device 110 triggers the report after receiving an uplink grant from a network device.

In some example embodiments, the terminal device 110 may determine that the report is to be triggered if a buffer in the terminal device for at least one logic channel is not empty when the terminal device switches from the first mode to the second mode.

In some example embodiments, an apparatus capable of performing the method 500 (for example, the terminal device 110) may comprise means for performing the respective steps of the method 500. The means may be implemented in any suitable form. For example, the means may be implemented in a circuitry or software module.

In some example embodiments, the apparatus comprises: means for determining. at a terminal device, that a report is to be triggered after the terminal device switches from a first mode in which the terminal device does not monitor a Physical Downlink Control Channel (PDCCH) to a second mode in which the terminal device monitors the PDCCH; and means for triggering the report after receiving an uplink grant from a network device.

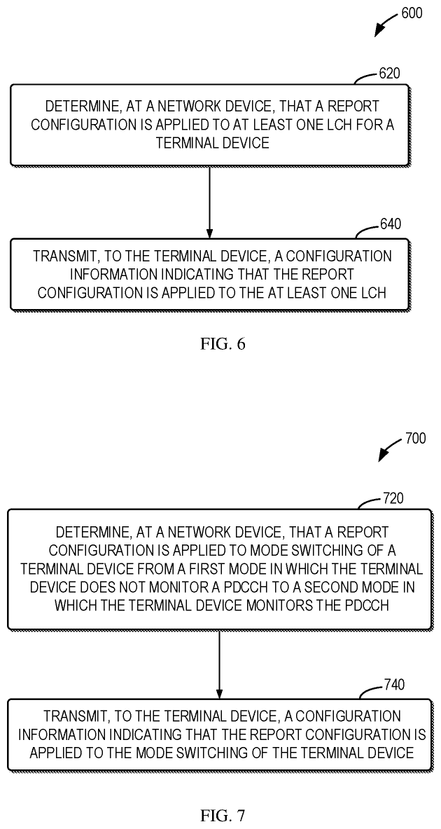

FIG. 6 illustrates an example method 600 of communication implemented at a terminal device in accordance with some embodiments of the present disclosure. For example, the method 600 may be performed at the network device 120 as shown in FIG. 1. For the purpose of discussion, in the following, the method 600 will be described with reference to FIG. 1. It is to be understood that the method 600 may include additional blocks not shown and/or may omit some blocks as shown, and the scope of the present disclosure is not limited in this regard.

At block 620, the network device 120 determines that a report configuration is applied to at least one logic channel for the terminal device 110. Based on the report configuration, the terminal device 110 may be configured to determine that a report is to be triggered when or after uplink data arrives in an empty buffer in the terminal device for the at least one logic channel and trigger the report after receiving an uplink grant from the network device. At block 640, the network device 120 transmits, to the terminal device, configuration information indicating that the report configuration is applied to the at least one logic channel. With the method of FIG. 6, an efficient mechanism to trigger a report for every data burst may be defined.

In some example embodiments, the configuration information may comprise logic channel indicators of the at least one logic channel. In some example embodiments, the configuration information may comprise at least one Quality of Service (QOS) flow indicators indicating that the report indicator is applied to the at least one logic channel associated with the at least one QoS flow indicator. In some example embodiments, the configuration information may be transmitted via a Radio Resource Control (RRC) message. In some example embodiments, the network device 120 may transmit, to the terminal device, an uplink grant; and receive, from the terminal device, the report on uplink resources scheduled by the received uplink grant. In some example embodiments, the report may comprise at least one of a PHR and a BSR.

In some example embodiments, the network device 120 may determine that the report configuration is further applied to mode switching of the terminal device from a first mode in which the terminal device does not monitor a Physical Downlink Control Channel (PDCCH) to a second mode in which the terminal device monitors the PDCCH. The network device 120 may transmit, to the terminal device, configuration information indicating that the report configuration is applied to the mode switching of the terminal device.

In some example embodiments, an apparatus capable of performing the method 600 (for example, the network device 120) may comprise means for performing the respective steps of the method 600. The means may be implemented in any suitable form. For example, the means may be implemented in a circuitry or software module.

In some example embodiments, the apparatus comprises: means for determining, at a network device, that a report configuration is applied to at least one logic channel for a terminal device, the report configuration configuring the terminal device to determine that a report is to be triggered when or after uplink data arrives in an empty buffer in the terminal device for the at least one logic channel and trigger the report after receiving an uplink grant from the network device; and means for transmitting, to the terminal device, configuration information indicating that the report configuration is applied to the at least one logic channel.

FIG. 7 illustrates an example method 700 of communication implemented at a terminal device in accordance with some embodiments of the present disclosure. For example, the method 700 may be performed at the network device 120 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard. With the method of FIG. 7, a report triggering mechanism is defined where the report may be triggered at the earliest for each wakeup of the terminal device when UL grant is available.

At block 720, the network device 120 determines that a report configuration is applied to mode switching of a terminal device from a first mode in which the terminal device does not monitor a Physical Downlink Control Channel (PDCCH) to a second mode in which the terminal device monitors the PDCCH. Based on the report configuration, the terminal device is configured to determine that a report is to be triggered after the terminal device switches from the first mode to the second mode and trigger the report after receiving an uplink grant from the network device. At block 740, the network device 120 transmits, to the terminal device 110, configuration information indicating that the report configuration is applied to the mode switching of the terminal device.

In some example embodiments, an apparatus capable of performing the method 700 (for example, the network device 120) may comprise means for performing the respective steps of the method 700. The means may be implemented in any suitable form. For example, the means may be implemented in a circuitry or software module.

In some example embodiments, the apparatus comprises: means for determining that a report configuration is applied to mode switching of a terminal device from a first mode in which the terminal device does not monitor a Physical Downlink Control Channel (PDCCH) to a second mode in which the terminal device monitors the PDCCH, the report configuration configuring the terminal device to determine that a report is to be triggered after the terminal device switches from the first mode to the second mode and trigger the report after receiving an uplink grant from the network device; and means for transmitting, to the terminal device, configuration information indicating that the report configuration is applied to the mode switching of the terminal device.

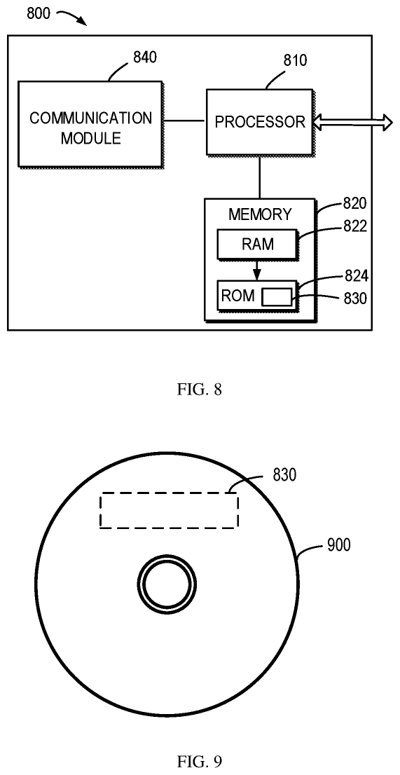

FIG. 8 is a simplified block diagram of a device 800 that is suitable for implementing embodiments of the present disclosure. The device 800 may be provided to implement the communication device, for example the terminal device 110 and the network device 120 as shown in FIG. 1. As shown, the device 800 includes one or more processors 810, and one or more communication modules 840 coupled to the processor 810. The device 800 may further include one or more memories 820 coupled to the processor 810.

The communication module 840 may be for bidirectional communications. The communication module 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the ROM 824. The processor 810 may perform any suitable actions and processing by loading the program 830 into the RAM 822.

The embodiments of the present disclosure may be implemented by means of the program 830 so that the device 800 may perform any process of the disclosure as discussed with reference to FIGS. 4 to 7. The embodiments of the present disclosure may also be implemented by hardware or by a combination of software and hardware.

In some embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. FIG. 9 shows an example of the computer readable medium 900 in form of CD or DVD. The computer readable medium has the program 830 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out any of the methods 400, 500, 600 and 700 as described above with reference to FIGS. 4-7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor; and
at least one memory comprising computer program code,
wherein the at least one memory and the computer program code are configured to, with the at least one processor, cause the terminal device to:
determine that a report is to be triggered when uplink data arrives in an empty buffer in the terminal device for at least one logic channel; and
trigger the report after receiving an uplink grant from a network device.

2. The terminal device of claim 1, wherein the terminal device is further caused to:
transmit the report to the network device on uplink resources scheduled by the received uplink grant.

3. The terminal device of claim 1, wherein the terminal device is caused to:
set a report indicator associated with the at least one logic channel to be a first value when the uplink data arrives in the empty buffer for the at least one logic channel, the set report indicator with the first value indicating that the report is to be triggered.

4. The terminal device of claim 1, wherein the terminal device is caused to:
set a report indicator associated with a logic channel group comprising the at least one logic channel to be a first value when the uplink data arrives in the empty buffer for the at least one logic channel, the set report indicator with the first value indicating that the report is to be triggered.

5. The terminal device of claim 3, wherein the terminal device is further caused to:
set the report indicator to be a second value different from the first value indicating that the report is not to be triggered.

6. The terminal device of claim 5, wherein the terminal device is further caused to:
set the report indicator to be the second value after transmitting the triggered report to the network device.

7. The terminal device of claim 5, wherein the terminal device is further caused to:
set an initial value of the report indicator to be the second value.

8. The terminal device of claim 5, wherein the terminal device is further caused to:
prevent to trigger the report after receiving the uplink grant from the network device when the report indicator set to be the second value.

9. The terminal device of claim 5, wherein:
the first value is 0 and the second value is 1; or
the first value is 1 and the second value is 0.

10. The terminal device of claim 1, wherein the determining is based on a report configuration for the at least one logic channel.

11. The terminal device of claim 10, wherein the terminal device is further caused to:
receive, from the network device, configuration information indicating that the report configuration is applied to a set of logic channels, the at least one logic channel belonging to the set of logic channels.

12. The terminal device of claim 11, wherein the configuration information comprises logic channel indicators of the set of logic channels.

13. The terminal device of claim 11, wherein the configuration information comprises at least one Quality of Service (QOS) flow indicators indicating that the report configuration is applied to the set of logic channels associated with the at least one QoS flow indicators.

14. The terminal device of claim 11, wherein the configuration information is received via a Radio Resource Control (RRC) message.

15. The terminal device of claim 1, wherein the report comprises at least one of:
a Power Headroom Report (PHR), and
a Buffer Status Report (BSR).

16. The terminal device of claim 1, wherein the terminal device is further caused to:
determine that the report is to be triggered after the terminal device switches from a first mode in which the terminal device does not monitor a Physical Downlink Control Channel (PDCCH) to a second mode in which the terminal device monitors the PDCCH.

17. A terminal device comprising:
at least one processor; and
at least one memory comprising computer program code,
wherein the at least one memory and the computer program code are configured to, with the at least one processor, cause the terminal device to:
determine that a report is to be triggered after the terminal device switches from a first mode in which the terminal device does not monitor a Physical Downlink Control Channel (PDCCH) to a second mode in which the terminal device monitors the PDCCH; and
trigger the report after receiving an uplink grant from a network device.

18. The terminal device of claim 17, wherein the terminal device is caused to determine that the report is to be triggered if a buffer in the terminal device for at least one logic channel is not empty when the terminal device switches from the first mode to the second mode.

19-26. (canceled)

27. A method implemented at a terminal device comprising:
determining that a report is to be triggered when uplink data arrives in an empty buffer in the terminal device for at least one logic channel; and
triggering the report after receiving an uplink grant from a network device.

28-34. (canceled)

35. A computer-readable storage medium having instructions stored thereon, the instructions, when executed on at least one processor, cause the least one processor to perform the method of claim 27.
